(19) United States
(12) Patent Application Publication
(10) Pub. No.: US 2018/0141791 A1
(43) Pub. Date: May 24, 2018

(54) Hydraulic Jack System

(71) Applicant: 692324 NB Inc., Moncton (CA)

(72) Inventors: Pat Jones, Dieppe (CA); Michael Deroy, Dieppe (CA); Mitchell Weir, Dieppe (CA); Matthew Taws, Dieppe (CA)

(21) Appl. No.: 15/647,731

(22) Filed: Jul. 12, 2017

Related U.S. Application Data
(60) Provisional application No. 62/423,925, filed on Nov. 18, 2016.

(51) Int. Cl. B66F 3/24; E01D 19/02; E01D 22/00; E02D 35/00

(52) U.S. Cl. CPC B66F 3/24; E01D 19/02; E01D 19/00; E02D 35/00; E01D 22/00

(57) ABSTRACT

A hydraulic jack system for lifting a load is disclosed comprising a hydraulic cylinder having a hydraulic piston for displacing loads and a locking ring for locking the hydraulic cylinder in place when pressure is removed from the hydraulic cylinder. The jack system also has a gear operatively connected to the locking ring for displacement of the locking ring and a top plate connected to the hydraulic piston for receiving the load. A bottom plate connected to the hydraulic cylinder to provide support to the hydraulic cylinder is also disclosed and, securing means for attaching the bottom plate to the hydraulic cylinder wherein the securing means allow for movement of the bottom plate when the hydraulic jack system is lifting a load.

### CROSS-REFERENCE TO RELATED APPLICATIONS

This application claims priority to U.S. Provisional Application No. 62/423,925, filed Nov. 18, 2016, the entire disclosure of which is hereby incorporated by reference herein.

### FIELD OF THE INVENTION

The present invention relates generally to a hydraulic jack system and more specifically to a hydraulic jack system used for positioning loads such as bridge piers in their final position.

### BACKGROUND

The placement and positioning of large piers requires the piers to be leveled at specified elevations in deep water. The positioning of these piers in deep water requires consideration for water currents making working conditions very difficult. Therefore, there is a need for a hydraulic jack system controlled on a platform by a single individual with cameras and controls for safety and accuracy in the positioning of these piers.

### SUMMARY

In a first aspect, the present invention provides a hydraulic jack system for lifting a load comprising a hydraulic cylinder having a hydraulic piston for displacing loads and a locking ring for locking the hydraulic cylinder in place when pressure is removed from the hydraulic cylinder. The jack system also has a gear operatively connected to the locking ring for displacement of the locking ring and a top plate connected to the hydraulic piston for receiving the load. The jack system further has a bottom plate connected to the hydraulic cylinder to provide support to the hydraulic cylinder and securing means for attaching the bottom plate to the hydraulic cylinder wherein the securing means allow for movement of the bottom plate when the hydraulic jack system is lifting a load.

In a second aspect, the present invention provides a hydraulic system for use in a hydraulic jack system comprising a hydraulic cylinder having a hydraulic piston for displacing loads and a locking ring for locking the hydraulic cylinder in place when pressure is removed from the hydraulic cylinder. The hydraulic system also has a gear operatively connected to the locking ring for displacement of the locking ring when the hydraulic piston is displaced.

### BRIEF DESCRIPTION OF THE DRAWINGS

It will now be convenient to describe the invention with particular reference to one embodiment of the present invention. It will be appreciated that the drawings relate to one embodiment of the present invention only and are not to be taken as limiting the invention.

FIG. 1 is a perspective view of the hydraulic jack system according to one embodiment of the present invention;

FIG. 2 is a perspective view of the hydraulic jack system with the top plate removed from the system according to one embodiment of the present invention;

FIG. 3 is a perspective view of a hydraulic cylinder used in the hydraulic jack system according to one embodiment of the present invention;

FIG. 4 is a side view of a hydraulic cylinder having the outer shell transparent as used in the hydraulic jack system according to one embodiment of the present invention;

FIG. 5 is a perspective view of the hydraulic jack system with the hydraulic cylinder fully extended according to one embodiment of the present invention;

FIG. 6 is a perspective view of the hydraulic jacking system with the locking ring lowered on the hydraulic piston allowing for the hydraulic jack to be lowered according to one embodiment of the present invention;

FIG. 7 is a magnified view of the operative connection between the locking ring and the gear as used in the hydraulic jack system according to one embodiment of the present invention;

FIG. 8 is a perspective view of the hydraulic motor set within the hydraulic motor mount as used in the hydraulic jack system according to one embodiment of the present invention;

FIG. 9 is an perspective view of the bottom plate in connection with the ball-joint system as used in the hydraulic jack system according to one embodiment of the present invention;

FIG. 10 is an side view of the ball-joint system, with the knuckle joint shown as transparent, according to one embodiment of the present invention; and

FIG. 11 is a side view of the hydraulic jack system having markings on the hydraulic cylinder allowing for better positioning of a load place on the hydraulic jack system according to one embodiment of the present invention.

### DETAILED DESCRIPTION

The present invention will now be described more fully hereinafter with reference to the accompanying drawings, in which preferred and other embodiments of the invention are shown. No embodiment described below limits any claimed invention and any claimed invention may cover processes or apparatuses that are not described below. The claimed inventions are not limited to apparatuses or processes having all the features of any one apparatus or process described below or to features common to multiple or all of the apparatuses described below. It is possible that an apparatus or process described below is not an embodiment of any claimed invention. The applicants, inventors or owners reserve all rights that they may have in any invention claimed in this document, for example the right to claim such an invention in a continuing application and do not intend to abandon, disclaim or dedicate to the public any such invention by its disclosure in this document.

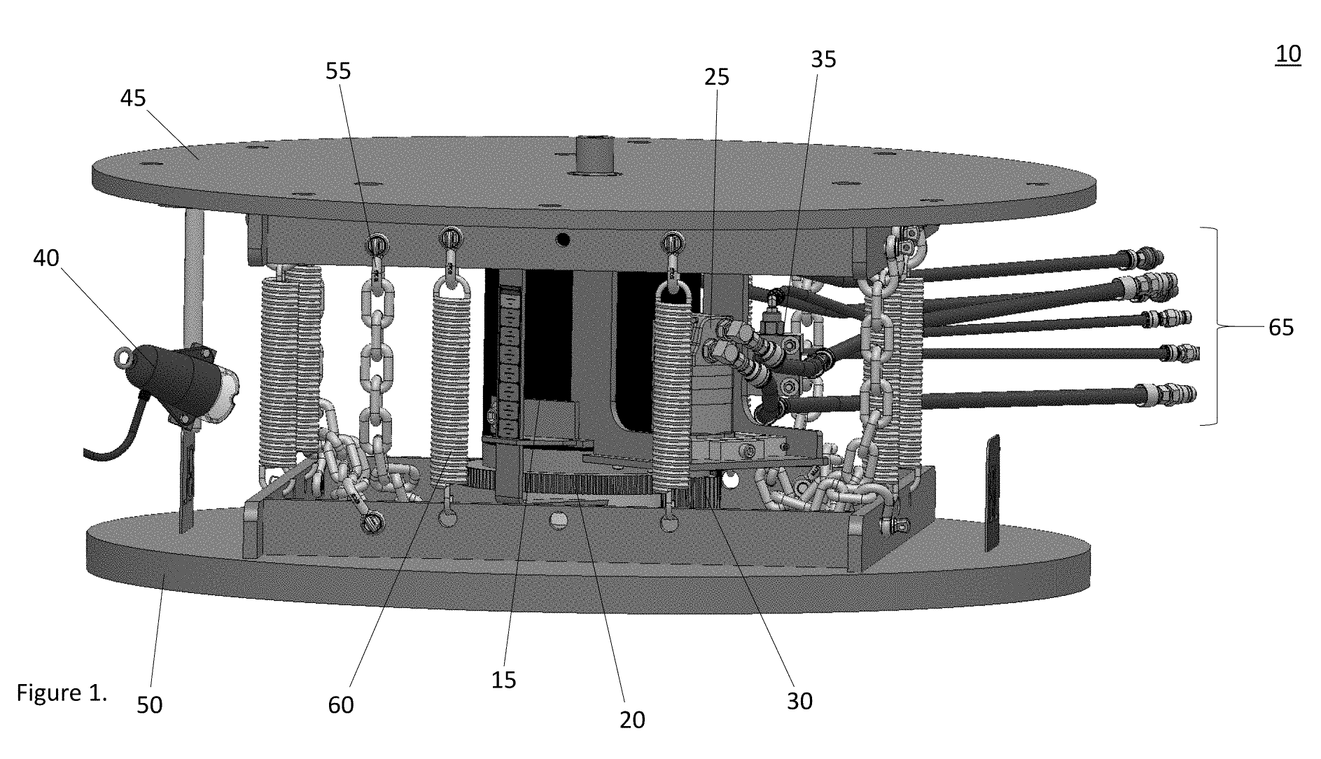

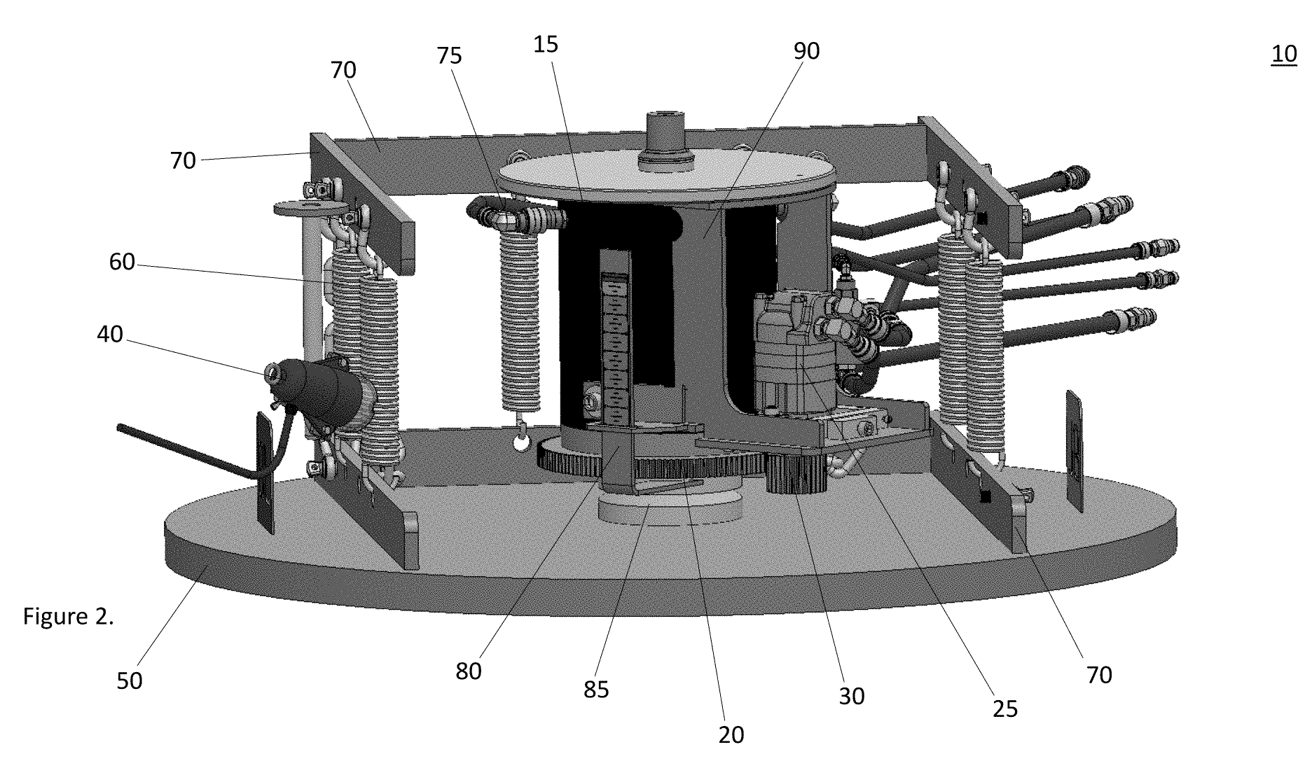

With reference to FIGS. 1 and 2, and according to one embodiment of the present invention, a hydraulic jack system 10 is described in greater detail. The hydraulic jack system 10 is primarily comprised of: a hydraulic cylinder 15; a locking ring 20; a gear 30 operatively connected to the locking ring 20; a top plate 45; a bottom plate 50 and securing means comprised of chains 55 and springs 60. In one example, the hydraulic jack system 10 of the present invention is used for positioning bridge piers in their final position. In one example of use of the present invention, one or more hydraulic jack systems 10 are placed underneath bridge piers (not shown) and are used to raise or lower the bridge piers after they have been set (not shown) thereby ensuring the appropriate height of each bridge pier (not shown). Once the hydraulic jack system 10 sets the bridge pier (not shown) to the appropriate height, the hydraulic jack system 10 is sacrificed as concrete is poured at the base of the bridge pier (not shown) and around the hydraulic jack system 10, thereby permanently setting the bridge pier (not shown). A camera 40 provides the user the ability to control the hydraulic jack system 10 from a remote location. A user, at a remote location, can observe the extension or retraction of the hydraulic cylinder 15 while observing other key aspects relating to the operation of the hydraulic jack system 10. The locking ring 20 follows the path of the hydraulic piston (not shown) through the rotational force supplied by the hydraulic motor 25. The outer surface of the hydraulic piston (not shown) is threaded, thereby allowing the locking ring 20 to move along the hydraulic piston (not shown) as the hydraulic cylinder 15 travels upward. As the locking ring 20 follows the travel of the hydraulic piston (not shown) the locking ring 20 provides a platform for the hydraulic cylinder 15 to rest atop upon the removal of hydraulic pressure or in the case of an emergency. The bottom plate 50 is designed in a manner whereby small angle variations of the ocean/lake/river floor such as between 0.1 degrees to 30 degrees. Even if the ocean/lake/river floor is on a slight angle, the bottom plate will automatically adjust, thereby allowing the hydraulic cylinder and hydraulic piston to be aligned vertically. The securing means are comprised of a series of chains 55 and springs 60 keep the lower plate 50 positioned within the hydraulic puck jacking system 10. Hydraulic lines 65 provide the hydraulic flow to the hydraulic cylinder 15 and the hydraulic motor 25 to power gear 30. Some of the hydraulic lines 65 are connected to the by-pass valve housing 35, where the hydraulic flow can be directed to a tank or the hydraulic motor as would be known by a worker skilled in the relevant art.

With specific reference to FIG. 2 and according to one embodiment of the present invention, the hydraulic jack system 10 is shown with the top plate removed from the present system. Also removed from the present system for ease of viewing are two plate which are identical to trusses 70 along with the chains and springs are also removed from the front facing portion of the hydraulic jack system 10. The plate trusses 70 are attached to the top plate (removed) and bottom plate 50, and allow placement of springs 60 and chains (not shown). The hydraulic cylinder 15 along with the hydraulic motor 25 and the locking ring 20 is set upon a ball-joint system 85. The ball-joint system 85 allows for small angular variations of the bottom plate 50 without affecting the angle of hydraulic cylinder 15. The camera 40 is positioned outside the central region of the hydraulic jack system 10 to capture a video feed of the hydraulic cylinder 15 and the height ruler 80. The height ruler 80 is a measuring guide for the user when viewing from a remote location. A ruler can also be used on the locking ring for fine adjustments wherein the thread pitch represents one rotation. It allows the user to determine the extension length that the hydraulic piston (not shown) has extended out from the hydraulic cylinder 15. The locking ring 20 is threaded onto the hydraulic piston (not shown) of the hydraulic cylinder 15 and is operatively connected to a gear 30 powered by hydraulic motor 25 through an outer gearing mechanism. The hydraulic motor 25 operates the gear 30, which in turn, spins the threaded locking ring 20 along the threaded hydraulic piston (not shown). The gear 30 is wider than the threaded locking ring 20, thereby allowing some travel of the threaded locking ring 20 along the gear 30 without the gear 30 and locking ring 20 rotating. This feature is described in more detail below.

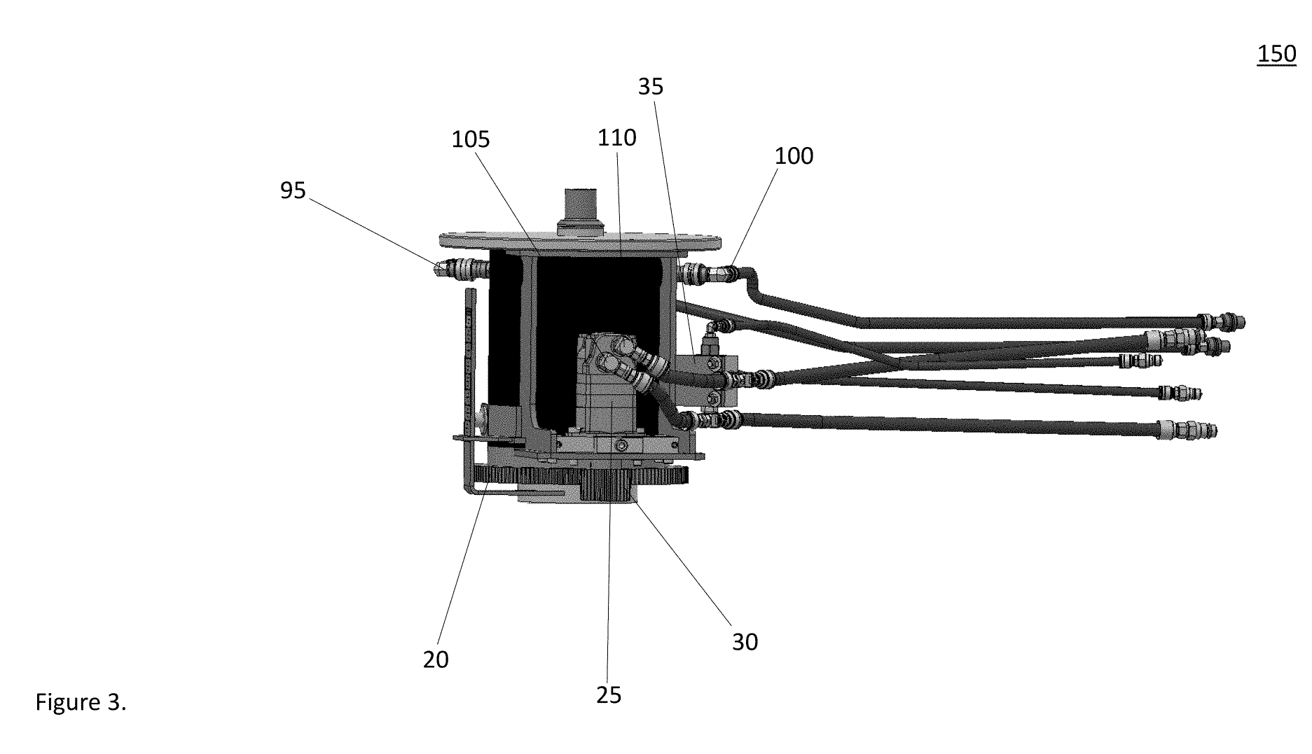

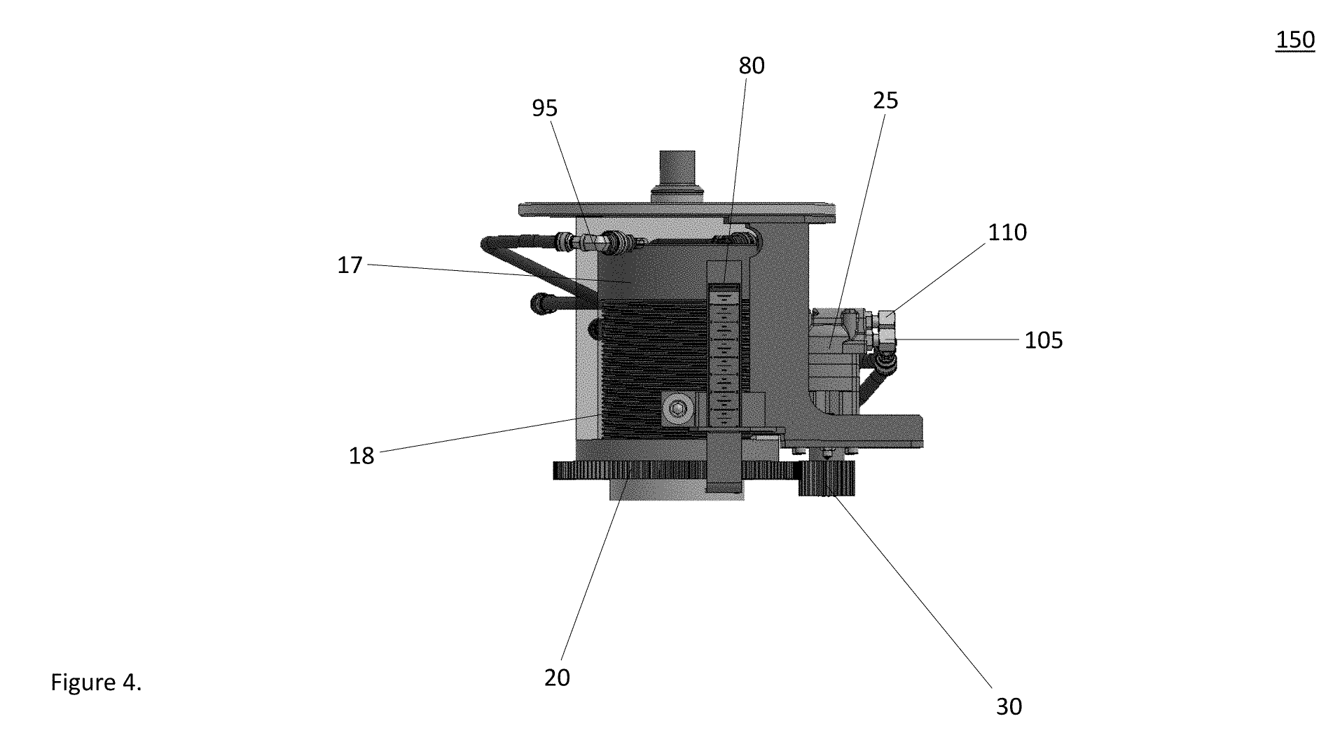

With reference to FIGS. 3 and 4 and according to one embodiment of the present invention, the hydraulic system 150 as used in the hydraulic jack system is shown in greater detail. The hydraulic system 150 is primarily comprised of: hydraulic cylinder 15; locking ring 20; hydraulic motor 25; a gear 30; hydraulic motor by-pass valve housing 35; and a hydraulic piston 17. The inlet and outlet hydraulic fluid lines ensure that hydraulic fluid is passed onto the hydraulic cylinder 15 and the hydraulic motor 25. The inlet and outlet hydraulic fluid lines as shown can be attached directly to the hydraulic cylinder, as seen with the hydraulic piston inlet and outlet, 95 and 100 respectively, or by through an intermediary such as pressure valve housing 35 as would be known by a worker skilled in the relevant art. The motor by-pass disable valve housing 35 modulates the pressure and flow of the hydraulic fluid entering or escaping from the hydraulic motor 25. Fluid can also be by-passed from the hydraulic motor to disable its operation. The modulation can be automatic or manual, dependant on the function required from the hydraulic motor 25.

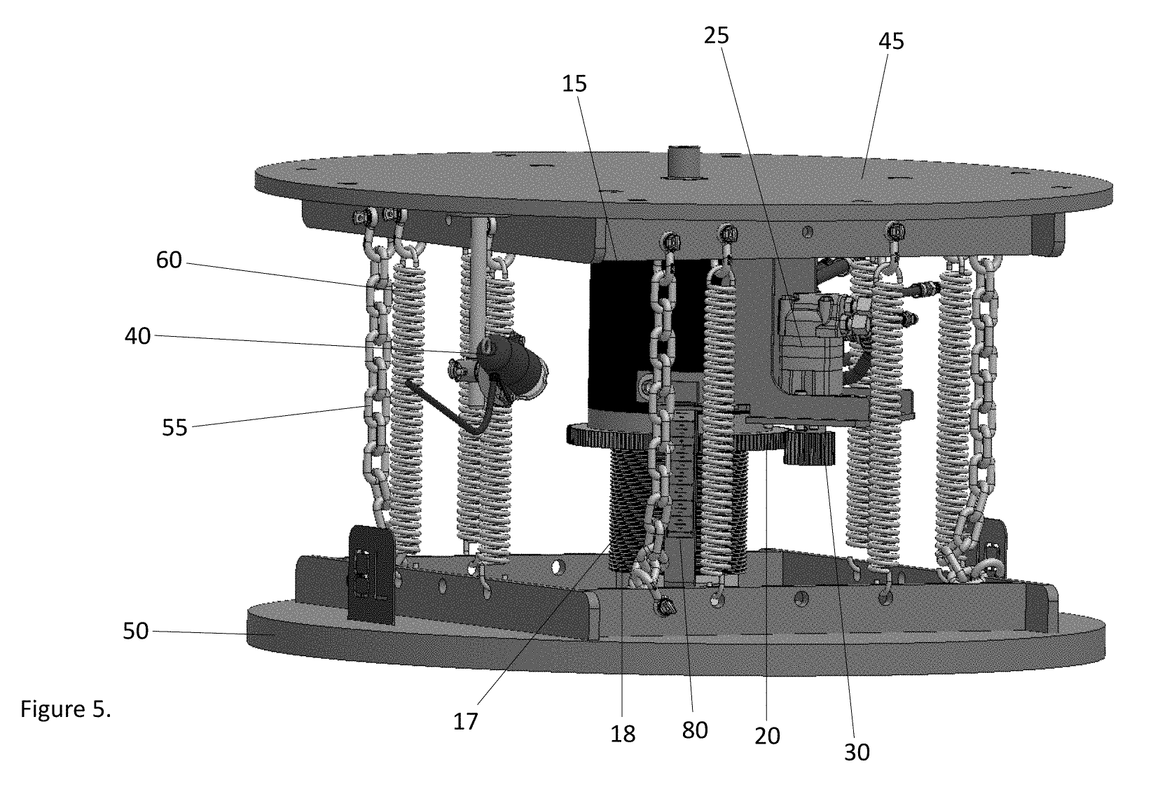

With specific reference to FIG. 5 and according to one embodiment of the present invention, the hydraulic jack system 10 is shown with the hydraulic cylinder 15 fully extended. Hydraulic fluid (not shown), when passed into the hydraulic jack system 10 allows for the hydraulic piston 17 to extend away from the hydraulic cylinder 15. As the hydraulic piston 17 extends from the hydraulic cylinder 15, the threaded region 18 on hydraulic piston 17 allows the locking ring 20 to be displaced along the hydraulic piston 17. The operative connection between the now displaced locking ring 20 and the gear 30 is maintained as the gear 30 is substantially larger than the threaded locking ring 20. The width of the gear 30 allows for the locking ring 20 to transverse the width of gear 30, and maintain an operative connected or geared interaction between the locking ring 20 and the screw gear 30, while the locking ring 20 is displaced along the threaded region 18 of the hydraulic piston 17. The locking ring 20 is displaced along the threaded region 18 by rotational force applied by the gear 30 powered by hydraulic motor 25 until the locking ring 20 abuts onto the hydraulic cylinder 15. The displacement of locking ring 20 along the hydraulic piston 17 occurs simultaneously with the extension of the hydraulic piston 17. Once the desired height extension is reached, the locking ring 20 is abutted against the hydraulic cylinder 15 thereby locking the cylinder in place

With further reference to FIG. 5 and according to one embodiment of the present invention, in in operation the hydraulic jack system 10 allows for a user to operate the system from a remote location by viewing a video feed captured and relayed by the camera 40. The video feed captured by the camera 40, includes the view of the hydraulic cylinder 15 and the height ruler 80. The height ruler 80 provides the user a defined measurement of the extension. The maximum extension of hydraulic piston 17 can be varied based on the application. It can reach extensions as high as 4 feet or less as an example. At the maximum hydraulic piston extension, springs 60 are fully extended and are exerting a force on the hydraulic cylinder 15. The force exerted by springs 60 also holds the bottom plate 50 to the hydraulic cylinder 15 and exerts a minimum force even when the hydraulic piston is not extended from the hydraulic cylinder 15. The chains 55 are not taut when the hydraulic piston is extended to its maximum position. The chains 55 provide an additional measure for maintaining the bottom plate 50 positioned directly below the top plate 45 as well as assure to keep the plate within the hydraulic jack system is any components of the system break.

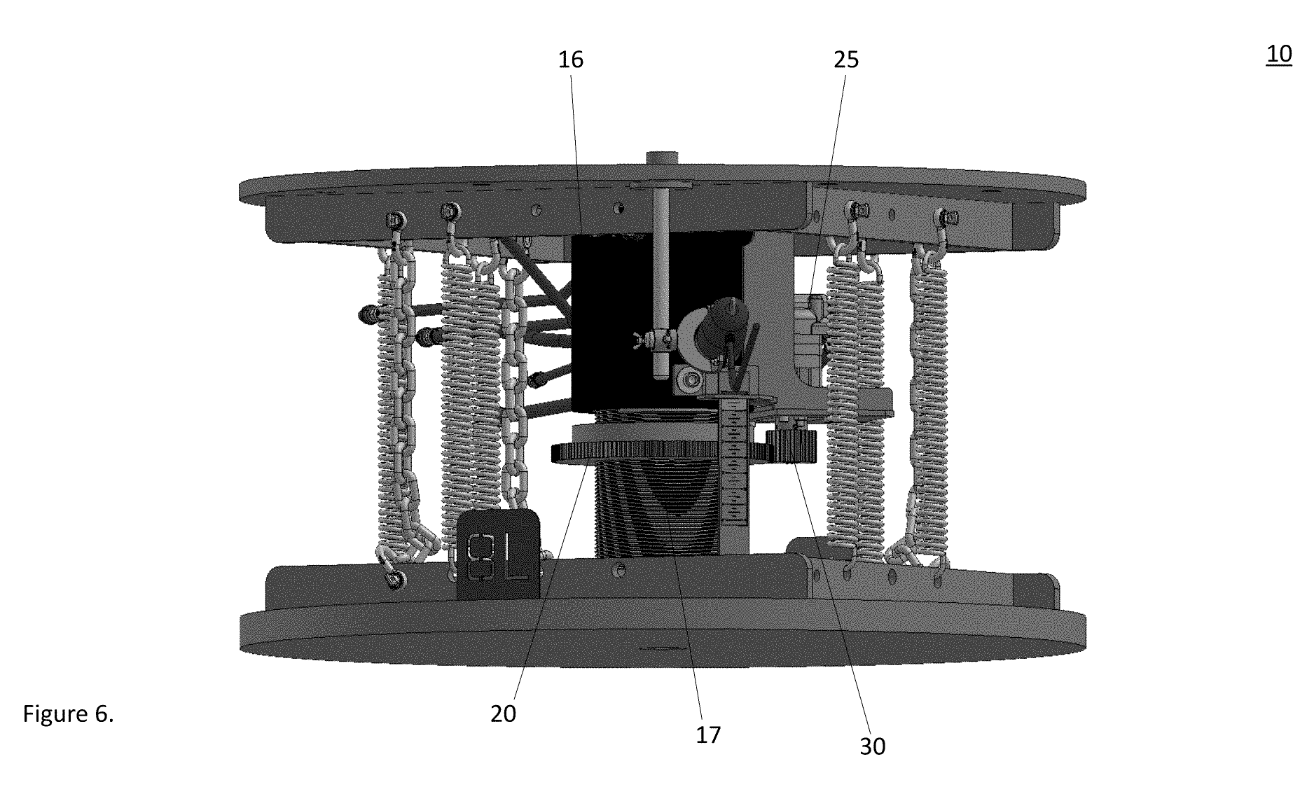

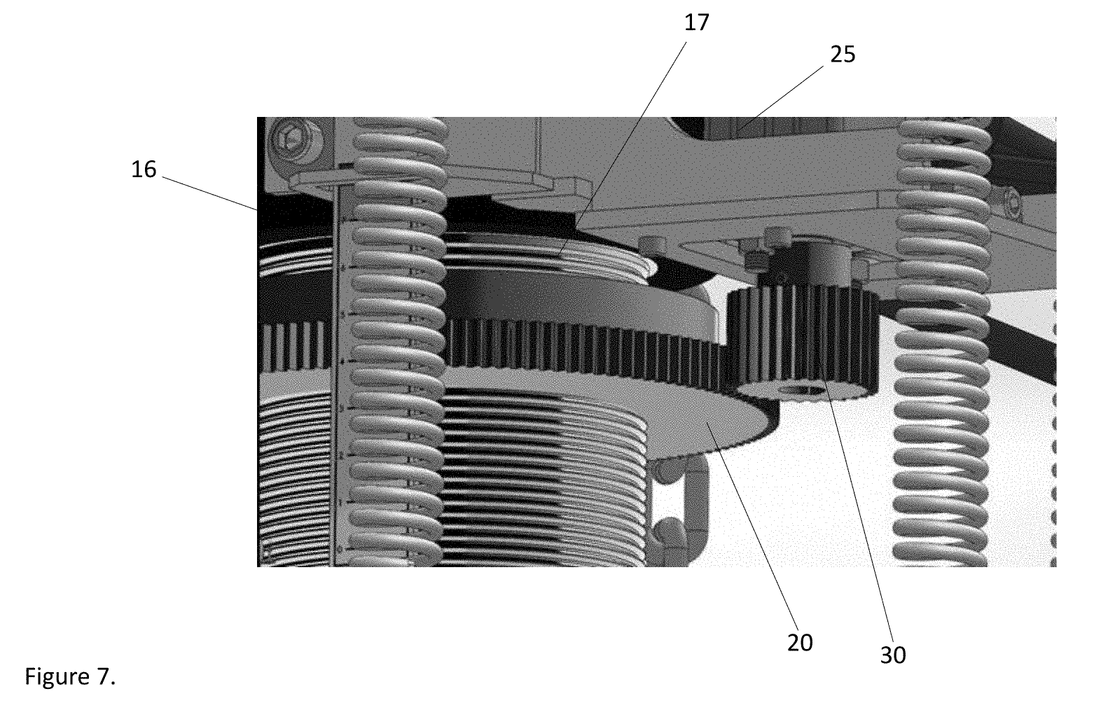

With specific reference to FIGS. 6 and 7 and according to one embodiment of the present invention, the hydraulic jack system 10 is shown when the hydraulic piston 17 is to be lowered from an extended position. For ease of viewing, the hydraulic jack system 10 is shown with some springs and chains removed from the system. In order to lower the hydraulic piston from an extended position the hydraulic cylinder has to be moved upwards providing a gap between the locking ring 20 and the hydraulic cylinder 15. This is accomplished by not moving the locking ring 20 and gear 30 and extending the hydraulic piston 17. The locking ring 20 can remain in position while the hydraulic piston 17 extends since the gear 30 has a larger width than the width of the locking ring 20. With the pressure release from the locking ring 20, gear 30 can lower the locking ring 20 along the threaded region of the hydraulic piston 17 while the hydraulic piston is lowered. Once the locking ring 20 has traversed the width of the gear 30, the hydraulic piston 17 can retract and the locking ring 20 can now simultaneously unwind while maintaining the gap between itself and the hydraulic cylinder 15. The locking ring 20 will be lowered until the desired height of the lowered hydraulic piston 17 is reached. At this point both the locking ring 20 and gear will remain static while the hydraulic cylinder 15 is lowered onto the locking ring 20 thereby locking the hydraulic cylinder 15 in place.

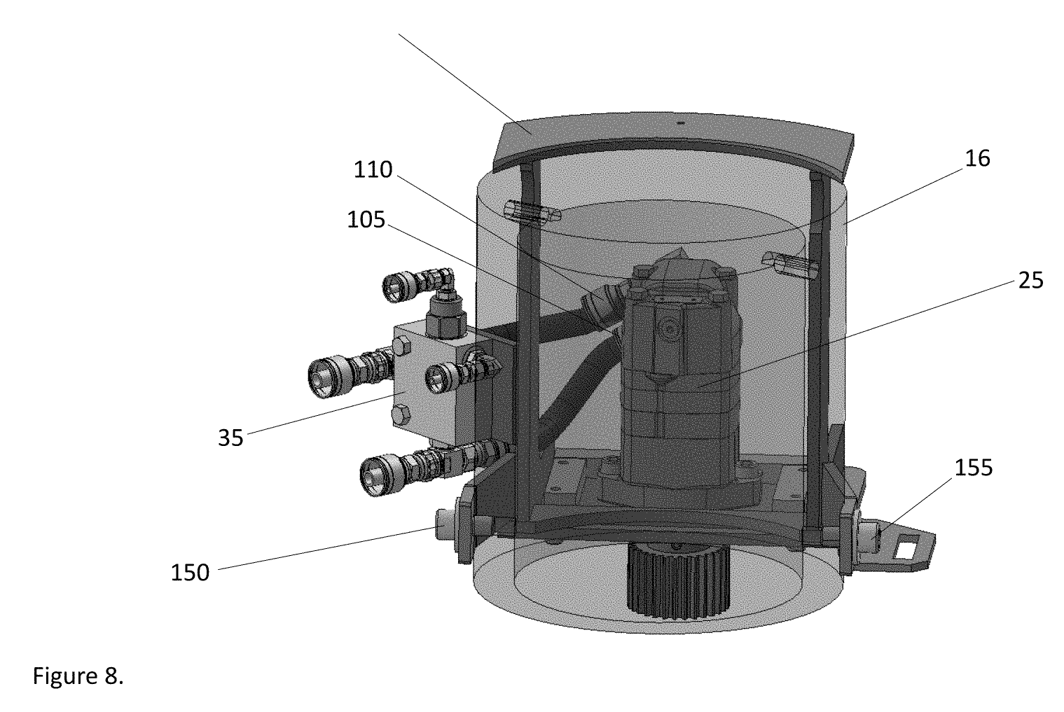

With reference to FIG. 8 and according to one embodiment of the present invention, the hydraulic motor 25 is shown operatively connected to the locking ring 20 and mounted within the hydraulic motor mount 115. The hydraulic motor mount 115 is welded onto the top plate (not shown) and attached to the hydraulic cylinder (shown as transparent) through the first and second locking screw, 150 and 155, respectively. The first and second locking screw, 150 and 155, respectively prevent any deformation of the hydraulic motor mount 115 due to torsion pressures. The hydraulic motor mount 115 houses the hydraulic motor 25 along with the by-pass valve housing 35 and the height indicator (not shown). As the hydraulic cylinder (shown transparent) is displaced vertically, the hydraulic motor 25 follows due it its attachment on the hydraulic motor mount 115. The locking ring (not shown) subsequently follows the path of the hydraulic cylinder by spinning along the hydraulic piston (not shown), spinning resulting from the rotation force applied to it by the hydraulic motor 25 through gear 30.

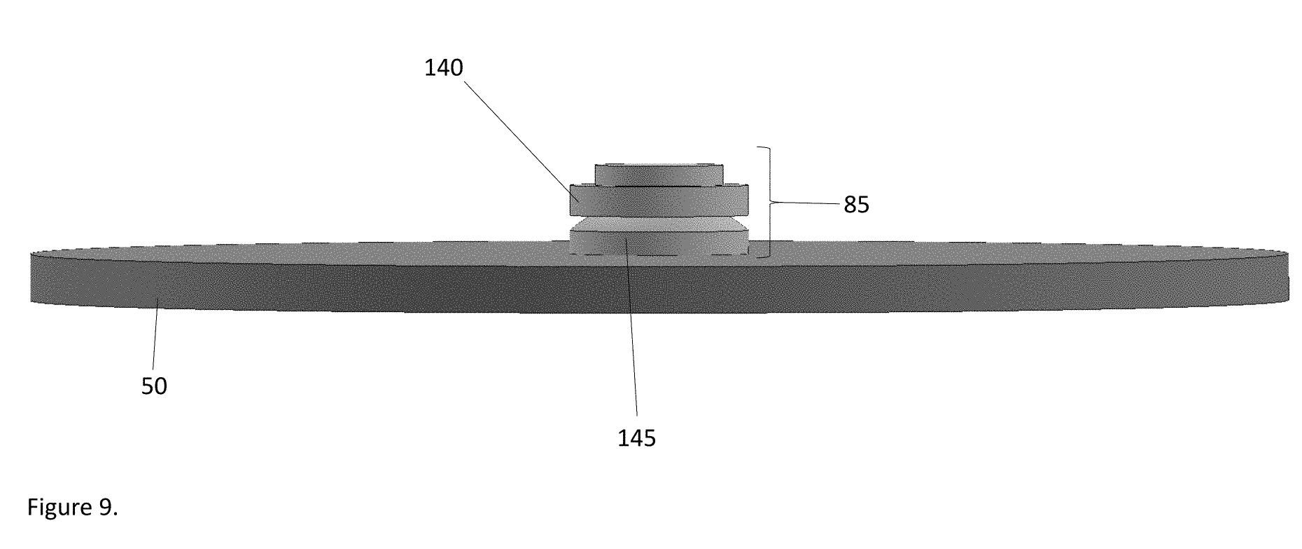

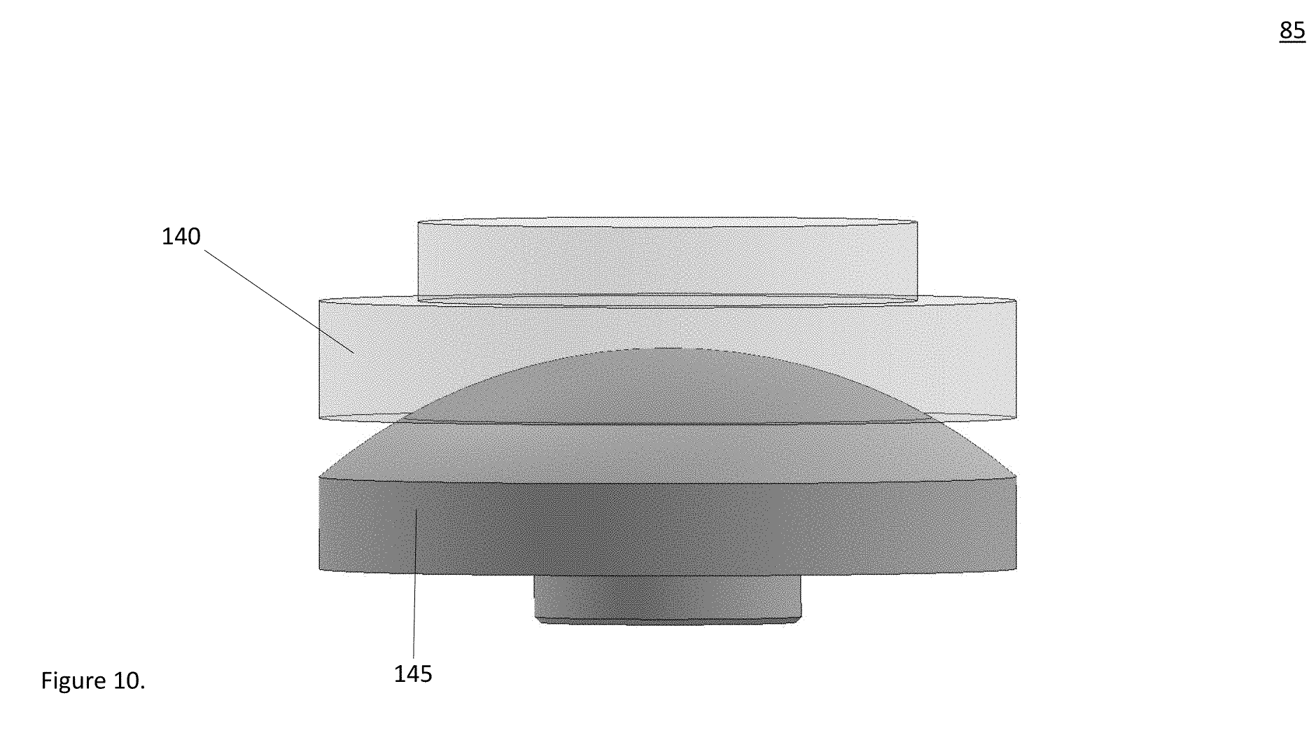

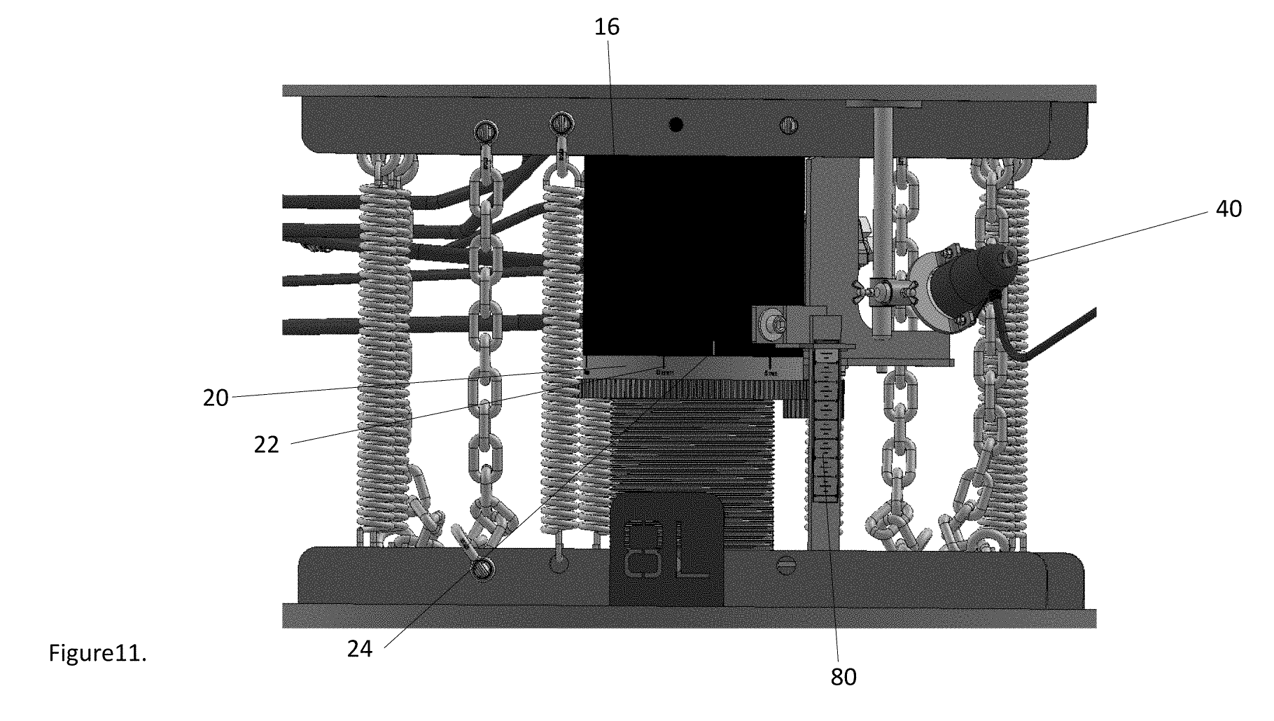

With reference to FIGS. 9 and 10 and according to one embodiment of the present invention a ball-joint system 85 is shown in greater detail. The ball-joint system 85 allows the hydraulic cylinder (not shown) of the hydraulic jack system (not shown) to be placed in a vertical position even when the ground is not completely flat or horizontal. Minor variations in the ground where the hydraulic jack system is positioned can cause the hydraulic cylinder (not shown) to be placed at an angle, thereby causing the hydraulic cylinder (not shown) to lift the weight of the bridge pier on an angle. Such weight, when balanced on an angle, can cause serious damage and deformation to the hydraulic cylinder (not shown). To alleviate such stress, the ball-joint system 85 can offset minor ground variations by allowing the hydraulic cylinder (not shown) to be positioned vertically even though the bottom plate 50 is positioned on an angle. For such flexibility to occur, the bottom plate 50 is not directly affixed to the hydraulic cylinder (not shown) as the ball-joint system 85 has no fixed attachment point. To keep the bottom plate 50 secured within the hydraulic puck jacking system (not shown), the bottom plate 50 is secured to the top plate (not shown) through a series of chains and springs (not shown). As such, the bottom plate 50 is securely affixed within the hydraulic puck jacking system (not shown) while also maintaining the ability to move around the center point of the ball-joint system 85. With specific reference to FIG. 11, the ball-joint system 85 is shown in greater detail. The ball-joint system 85 is comprised of a knuckle joint 140 and a ball joint 145. For ease of reference, the knuckle joint 140 is shown as transparent. The knuckle joint 140 has a round aperture where the round portion of the ball joint 145 is set within. The ball joint 145 is able to move within the ball-joint system 85 while maintaining complete contact with the knuckle joint 140. As such, angle variations on the ground, which translates to an angle variation on the bottom plate 50, is offset by the angle produced between the knuckle joint 140 and the ball joint 145.

With reference to FIG. 11 and according to one embodiment of the present invention, the locking ring 20 has markings 22 which indicate the height the hydraulic cylinder 16 has been raised based on the rotation of the locking ring 20. A marker 24 is positioned on hydraulic cylinder 16 and with every marking 22 that passes marker 24 a corresponding height is indicated through the rotation of the locking ring 20. The markings 22 are based on the pitch of locking ring 20 which provides a more accurate indication of the movement of hydraulic cylinder 16.

According to one embodiment of the present invention, a load can be defined as a bridge pier or any other heavy object which requires precise positioning under water or above water. In order for the present hydraulic jack system to be effective, the hydraulic jack system must be sacrificed and become part of a final footing encompassing the load to be positioned in a precise location.

According to one embodiment of the present invention, the securing means used can be a varying number of springs or any other device which applies pressure in order to maintain the bottom plate connected to the hydraulic system of the present invention.

According to one embodiment of the present invention, the hydraulic jack system assures that the locking ring is in contact with the top of the cylinder when the jack is extended. Therefore, the thread can only rotate and indicate a distance change if the cylinder extends (raises).

1. A hydraulic jack system for lifting a load comprising:
a. A hydraulic cylinder having a hydraulic piston for displacing loads;
b. A locking ring for locking the hydraulic cylinder in place when pressure is removed from the hydraulic cylinder;
c. A gear operatively connected to the locking ring for displacement of the locking ring;
d. A top plate connected to the hydraulic piston for receiving the load;
e. A bottom plate connected to the hydraulic cylinder to provide support to the hydraulic cylinder; and,
f. Securing means for attaching the bottom plate to the hydraulic cylinder wherein the securing means allow for movement of the bottom plate when the hydraulic jack system is lifting a load.

2. A hydraulic system for use in a hydraulic jack system comprising:
a. A hydraulic cylinder having a hydraulic piston for displacing loads;
b. A locking ring for locking the hydraulic cylinder in place when pressure is removed from the hydraulic cylinder; and
c. A gear operatively connected to the locking ring for displacement of the locking ring when the hydraulic piston is displaced.

3. Any invention as may be defined in the above description.
